(19) United States
(12) Patent Application Publication
(10) Pub. No.: US 2004/0197451 A1
(43) Pub. Date: Oct. 7, 2004

(54) Method and apparatus of cooking food

(76) Inventor: Mehdi Farid Mohammed, Auckland (NZ)

Correspondence Address: BROOKS KUSHMAN P.C., 1000 TOWN CENTER, TWENTY-SECOND FLOOR, SOUTHFIELD, MI, 48075, US

(21) Appl. No.: 10/480,767

(22) PCT Filed: Jun. 10, 2002
(86) PCT No.: PCT/NZ02/00108

(30) Foreign Application Priority Data
Jun. 14, 2001 (NZ) 512355

(51) Int. Cl. A23C 3/00

(52) U.S. Cl. 426/523

(57) ABSTRACT

The thawing and cooking time of frozen hamburger patties (9) at minus 20 degrees Celsius can be reduced by the combination of ohmic and plate heating. The frozen patties (9) are held between metallic plates (2 and 4) heated to at least 180 degrees Celsius and which also acts as electrical contacts with the patties (9). Each plate is connected to a source of alternating current (50, 20) supplying a peak power consumption of about 13 watts/sq.cm of surface area of each patty (9) to be heated, so that interior of the patties can be heated by an electric current passing through the patty (9) as the patty (9) is also heated by the plates (2 and 4).

### FIELD OF INVENTION

This invention relates to methods, apparatus and systems for cooking and has been devised particularly though not necessarily solely for use in cooking or heating up foodstuffs, particularly chilled or frozen food such as hamburger patties and sausages

### BACKGROUND OF THE INVENTION

Outbreaks of food poisoning due to undercooked food such as hamburger patties have been of major concern to the public in recent years. It is therefore important for food providers, particularly fast food providers, to have a quick and efficient yet safe way of cooking chilled or frozen food such as hamburger patties.

The ratio of diameter to thickness of a hamburger patty is large (usually above 10). The cooking time is desirable to be relatively short, and thus the central temperature is of major interest to assure food safety.

Known methods or systems include the conventional contact-heating systems (e.g. a grill). Cooking with a grill has the shortcoming in that the chilled or frozen food is either undercooked at the centre, which may give rise to food safety problems, or overcooked at the surface, which leads to inferior textural quality of the food. It also has another disadvantage that the time required for defrosting or thawing and heating up frozen foodstuffs, the frozen temperature of which may be as low as −20° C., is too long for fast food stores where foodstuffs such as burgers have to be mass-produced within a short period of time.

Furthermore, with conventional double-sided contact heating, there may be a time delay to begin heating from top, as it takes some finite time to close the top heating grill plate. After the cooking process time has elapsed, the top heating plate is lifted up before the foodstuff being cooked, such as patties, are removed from the grill. This reduces the total heating time on the top-heating surface. The shorter heating time on the top may result in less energy delivery into the hamburger patties from the top surface when both heating surfaces have the same temperature. Therefore the slowest heating point may not be at the geometric centre of the patty. Conventionally, to achieve similar cooked quality characteristics on both top and bottom halves of a patty, a higher heating temperature on the top contacting means is normally used to compensate for the shorter heating time. The geometric centre of the patty however still cannot be precisely located, at least in a simple manner. Should this be the case, uneven cooking or heating may result.

It is therefore an object of the present invention to provide cooking methods, systems or apparatus which will at least go some way towards overcoming the foregoing disadvantages or will at least provide the public with a useful choice.

### SUMMARY OF THE INVENTION

In one aspect the invention be broadly be said to consist in a method of heating or thawing or cooking a foodstuff wherein the foodstuff is contacted by at least two surface heating means is and an electric current is passed through the foodstuff to provide ohmic heating of the interior thereof.

Preferably the current is an alternating electric current applied at between 30 and 100 Volts.

Preferably each of the surface heating means is connected to an electrical power source, and each surface heating means has an electrically conductive surface to provide an electrical contact with the foodstuff.

Preferably a method as claimed in claim 3, wherein the electrical current is applied at about 70 Volts.

In another aspect the present invention may broadly be said to consist in a method of cooking frozen hamburger patties which includes the steps of contacting the frozen patties with at least two surfaces heated to at least 180° C. and passing an alternating electric current of between 30 and 100 Volts through the patties to provide ohmic heating of the interior thereof.

Preferably the ohmic heating provides a peak power consumption of about 13 watts/cm² of surface area of each patty to be heated. A higher or lower power consumption may be required for patties of different thicknesses.

In a further aspect the present invention may broadly be said to consist in apparatus suitable for heating or thawing or cooking a foodstuff which include at least two heating means capable of supplying heat to the surface of the foodstuff, and at least two contacting means both being connectable to an electrical power source and capable of allowing an alternating current to flow through at least a portion of the foodstuff to provide ohmic heating of the interior thereof.

Preferably each of the at least two heating means also functions as one of the at least two contacting means.

Preferably means is provided to hold the heating means in electric and thermal contact with the foodstuff.

Preferably the two contacting means are provided in a clam-shell arrangement

### INVENTIVE STEP

The combination of ohmic and plate heating when applied to frozen foodstuffs such as frozen hamburger patties frozen at typically minus 20° C. to speed up the thawing and cooking time as the ohmic heating is self regulating. Initially the deep frozen foodstuff does not conduct electricity but as the surface starts to thaw, conduction starts and the electrical current heats the interior of the foodstuff, as the foodstuff starts to dry out near the end of its cooking cycle the foodstuff becomes less electrically conductive and the flow of current through the foodstuff diminishes.

### DRAWINGS AND EXAMPLES

To those skilled in the art to which the invention relates, many changes in constructions and widely different embodiments and applications of the invention will suggest themselves without departing from the scope of the invention as defined in the appended claims. The disclosure and descriptions herein are purely illustrative and are not intended to be in any sense limiting.

One presently preferred embodiment of the invention will now be described with reference to the accompanying drawings, wherein:

FIG. 1 is a perspective view of an apparatus for cooking particularly but not solely chilled or frozen food, in accordance with the present invention

FIG. 2 is a graph showing the relationship between the temperature of the centre of the food and time at various voltages when the apparatus of FIG. 1 is in use.

FIG. 3 is another graph showing the relationship between the temperature of the centre of the food and time at different voltages when the apparatus of FIG. 1 is in use.

FIG. 4 is a cross sectional view of the apparatus of FIG. 1.

FIGS. 5a and b are cross sectional views of a second embodiment of the apparatus of FIG. 1.

FIG. 6 shows the experimental set up for the measurement of temperature changes in the centre of a patty cooked by the apparatus of FIG. 1.

FIG. 7 is a graph showing the temperature profiles of a patty cooked by conventional heating and combined heating respectively.

FIG. 8 is a table listing the mechanical properties of patty samples obtained by conventional heating and the apparatus of FIG. 4.

FIG. 9 is a schematic diagram of loading and unloading curves of the patty samples as a result of the compression tests.

FIG. 10 shows the average elasticity indices of the two cooking methods.

FIG. 11 shows the average strength and stiffness values of the two cooking methods.

FIG. 12 is a table summarising the water and oil contents measurements

FIG. 13 shows a breakdown of the composition of the cooked patties

FIG. 14 is a schematic curves illustrating the relationship between the current and time when the apparatus of FIG. 4 is in operation

### DESCRIPTION

Glossary:

‘Ohmic heating or cooking (also known as ohmic-assisted cooking)’ broadly means a method of heating foodstuffs by way of making use of the electrical resistance of the foodstuffs. This method of cooking can be used in a general sense to cook raw food or to re-heat cooked food.

‘Conventional heating or cooking’ broadly means a way of heating foodstuffs that requires direct contact between the surfaces wherefrom the heat is emitted and the surfaces of the foodstuff to be heated.

‘Combined heating or cooking’ means heating foodstuffs by applying both ohmic heating and conventional heating, intermittently or continuously throughout the course of hang or cooking foodstuffs.

### EXAMPLE 1

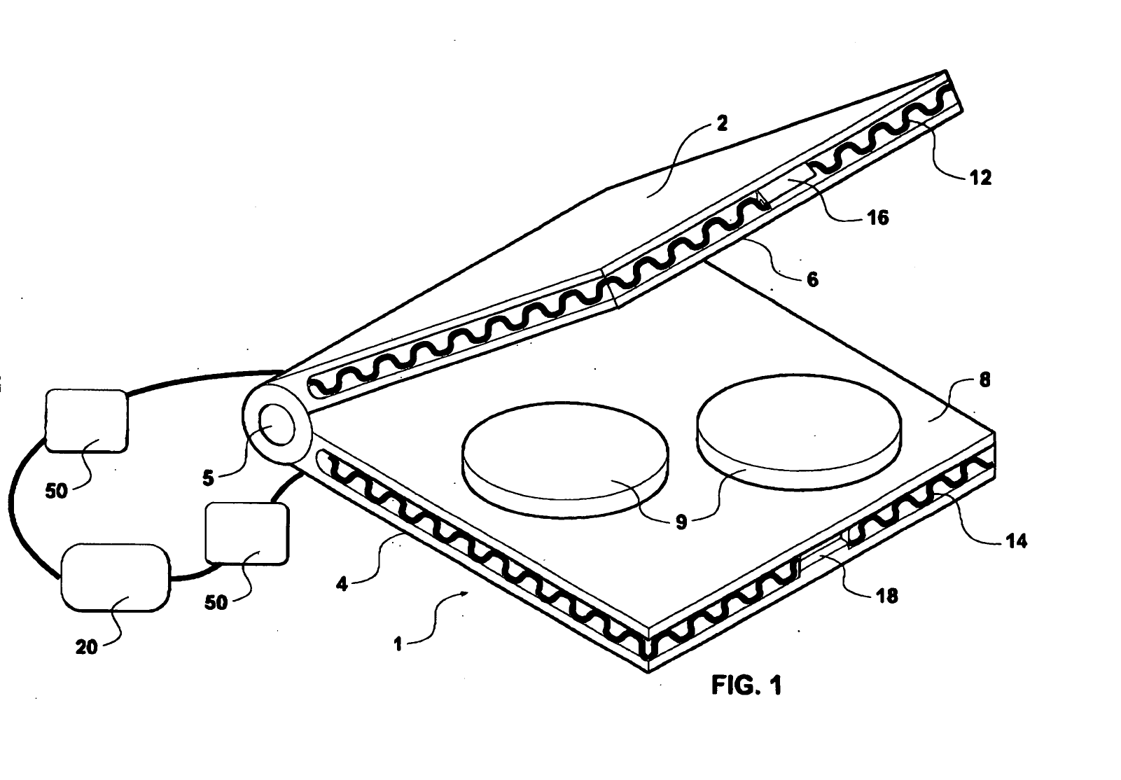

Referring to FIG. 1, an apparatus for cooking chilled or frozen food generally referenced 1 is shown. Preferably the apparatus comprises an upper contacting means 2 and a lower contacting means 4. The contacting means 2 & 4 are hingedly connected to each other by a non-conducting hinging means 5. It should be noted that for the present and all other embodiments of the present invention mentioned herein, the contacting means 2 and 4 must be electrically isolated from each other. Preferably the two contacting means are provided in a clamshell arrangement. Contacting surfaces 6 & 8 are provided in the form of a flat plate in the interior of the apparatus 1. The contacting surfaces comprise a substantially conductive material such as metal. Preferably the metal is non-stick and anti-corrosive. Alternatively, the metal can be coated so that the contacting surface is electrically conductive but non-stick and anticorrosive.

Heating means 12 & 14, from which heat is emitted, are provided in contacting means 2 & 4 respectively so as to render conventional contact heating (e.g. a grill). Preferably the heating means comprise electrical resistant heating elements. Preferably the heat emitted from the contacting surface can get up to 180 degrees Celsius or higher. A conductive coating layer is preferably provided so as to render better surface textural quality of the food.

In use, solid food to be cooked such as hamburger patties 9 are placed on the contacting surface 8. An alternating current is then applied across the patties 9. It is desirable that an alternating current is provided instead of a direct current, which may cause electrode deposition on to the surface of foodstuffs. Furthermore, a direct current set up will not be cost effective, as it will have to be polarised. Preferably the power supplied is powerful enough to kill most germs that may exist in foodstuffs. Preferably the patties 9 contains enough water or moisture to be electrically conductive (at least when heated slightly) so that a complete circuit is formed when the solid patties are placed between the contacting surfaces. The party may be frozen before being placed in the apparatus. The contacting means 2 & 4 are then closed and locked in position by locking means 16 & 18. The temperature of the entire body comprising the core of the patties will be raised due to its resistance when a current, which is generated by a power source 20, is passed through the patties. Preferably, each contacting means 2 and 4 (i.e. surface heating means) is connected to an electrical power source respectively. More preferably each contacting means 2 and 4 is connected to a power source 20 via a transformer 50, with which the output voltage can be adjusted to meet the needs of different types of patty with different thickness and ingredients etc. if necessary. Preferably the patties 9 contain enough water or moisture to be conductive when they are either first placed between the plates 2 and 4, or after a period of heating.

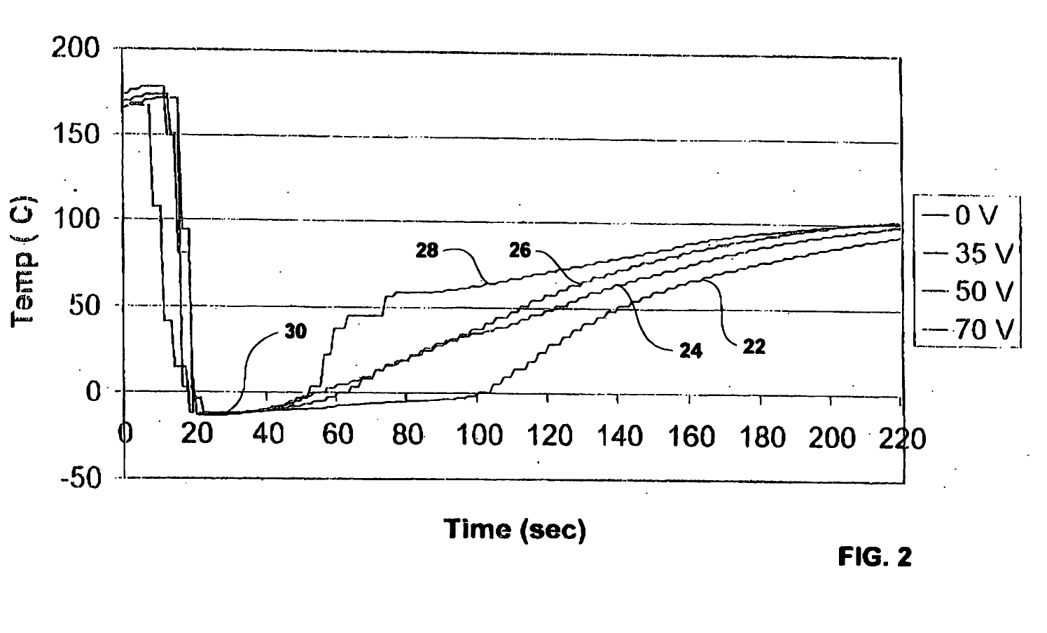

Turning now to FIG. 2, a graph, which demonstrates how the temperature of the core of a frozen hamburger patty changes with time at various voltages is shown. Although a steady power is supplied by the power source 20, the current, which passes through the patty, is substantially minimal initially as the resistance of the solid food is high. This gives rise to prolongations 30 of the curves 24, 26 & 28 which means that the temperature of the core of the food remains unchanged during that period of time.

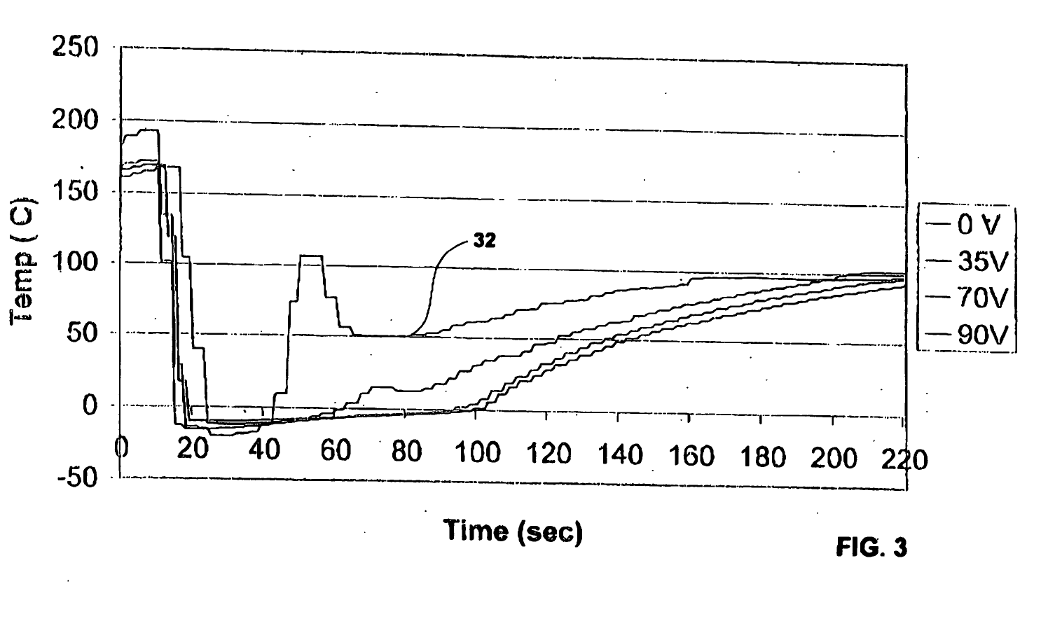

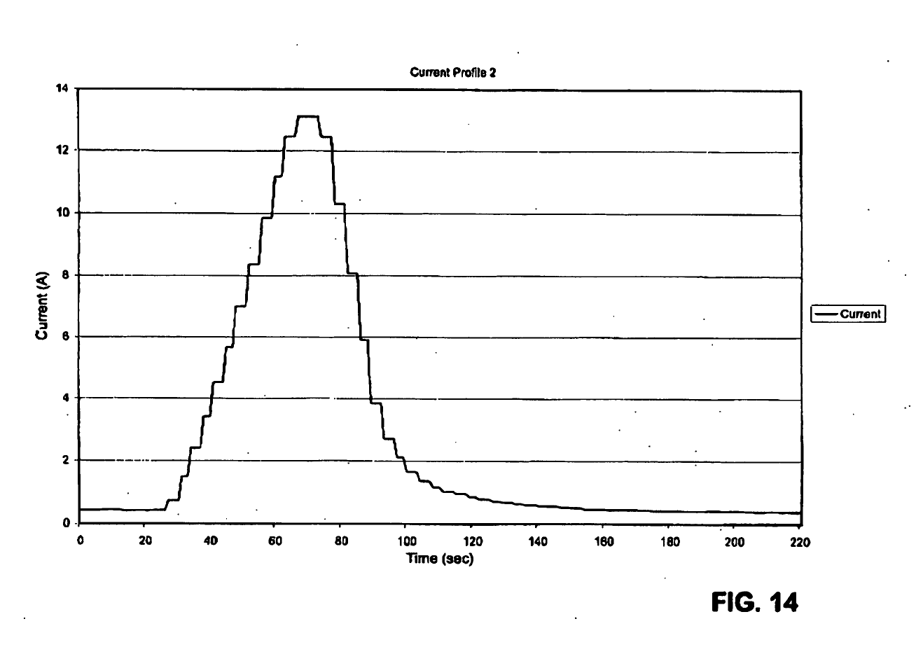

As the food thaws due to the heat rendered by heating means 12 & 14, the current and hence the temperature of the core of the hamburger patties 9 increase rapidly. This is a consequence of an increase in mobile H⁺ and OH⁻ ions, which largely reduce the patties' resistivity, during the melting of ice and fat. This rapid increase of temperature due to the heat generated by the current can be observed from the curves 24, 26 & 28 as opposed to curve 22 which shows how temperature changes over time without the application of apparatus 1 (i.e. cooking by conventional heating only). The current is preferred to be an alternating current applied at between 30 and 100 Volts. It can be observed and appreciated that the higher the voltage, the faster the temperature rises as shown by curves 28 (70V) & 32 (90V) in FIGS. 2 and 3 respectively. The ideal operating voltage however is envisaged to be around 70 Volts. In general the resistivity of a patty without any special pre-treatment varies from infinite at the extreme temperature of −20° C. to a minimum value of about 600 Ω.cm in the course of cooking. However, this may change slightly depending on the quality and ingredients of the meat. Based on burger patties that have a typical diameter 90 mm and a typical thickness of 6 mm, the minimum ohmic resistance is about 5.7Ω. It has been measured that a typical sized patty will pass a peak current of 12 Amps and thus consume a peak power of 821 W, when about 70V is applied. This essentially means that 0.19 Amp/cm² and 13 Watts/cm² are required to effectively heat up a patty to an extent that it is safe to be consumed. The total current and power required by an industrial machine will be the current and power mentioned above multiplied by the maximum number of patties that can be accommodated and cooked at the same time. It should be noted that a fixed voltage can be applied to patties with different diameters but the same thickness. The same voltage can be used regardless of the number of patties being cooked at the same time. A higher voltage is however required when thicker patties are cooked. It has been calculated that the voltage supplied should be directly proportional to the square root of the patties' thickness. Therefore, if for example the thickness of the patties increase from 6 mm to 8 mm, the voltage has to be increased from 70 volt to 81 Volts, or 90 to 104 Volts, so as to maintain the best performance of the device. It is envisaged that a lower voltage is required if the patties are pre-treated, for example by way of salting. Only a small quantity of salt (such as sodium or potassium chloride) is preferred to be applied for pre-salting the patties, as otherwise the current will be excessive thereby rendering an adverse effect. The pre-treatment of salting or any kind however is optional. As far as ohmic heating is concerned, the total energy required for defrosting and heating a standard sized (dimension as outlined above) patty is about 30 kJ. As the surface of the patties dry out and become crusty, the current decreases due to an increase in the resistance of the patties. For this reason, it can be envisaged that the relationship between current and time is as shown schematically in FIG. 14. Such a graph may be useful in that a relationship between the heating or cooking time and the current is established. In other words the current, which can be easily observed or monitored, can serve as an indicator of the readiness of the patty 9 for consumption. This is advantageous in that no temperature measuring device is required to be probed into the patty 9 in order for the cook to judge whether the patty, particularly its core, is heated to the required temperature or not. It takes much longer for the temperature of the core of the patty to rise from 50 to 100 degree Celsius. It is however generally required that hamburger pates only need to be cooked to 71° C. or 68° C. for 15 seconds. This can be achieved in a much shorter period of time by utilising the current invention as opposed to applying conventional heating only. The current can then be cut off independently by turning off the power supply while conventional heating can still be applied for further cooking or warming.

The major advantage offered by the current invention is that it provides a much more efficient (i.e. quicker) yet safe way of cooking solid food. This is particularly desirable in fast food restaurants. Additionally, the equipment of this invention allows the user to have the option of using conventional plate heating if business is slow and the user has more time to cook the patties.

It should be contemplated that the present invention can be improved by comprising a non-stick coating layer on top of the flat plates so as to render a better textural quality of the patties.

Before commencing operation, it is preferred that at least a gentle pressure rendered by for example a locking means (for household apparatus) or by a hydraulically controlled device (for commercial manufacturing facility) is provided to ensure that the patties 9 are in good contact with the contacting surfaces 6 and 8.

This preferred embodiment of the current invention is advantageous in that convenient employment of combined heating can be achieved. It should be noted that a synergy is evident in combined heating in a sense that it has a self-terminating feature. This feature is effected by the decrease of the current, which runs across the patties 9, due to an increase in the resistance of the patties as their surface becomes more and more crusty. In other words, the patties will not be overcooked by ohmic heating even if the switch for ohmic heating is not turned off or forgotten to be switched off inadvertently (as long as the conventional heating is monitored and under control).

It should be noted that the thin crust layer at the surface of a party is gradually developed during cooking as the temperature exceeds the evaporation point of water. The crust layer determines the sensory quality of cooked patties.

As a safety precaution, a microswitch or the like (not shown) is preferably provided such that ohmic heating can come into operation only when the microswitch is activated (for example by the closing mechanism of the upper contacting means 2).

### EXAMPLE 2

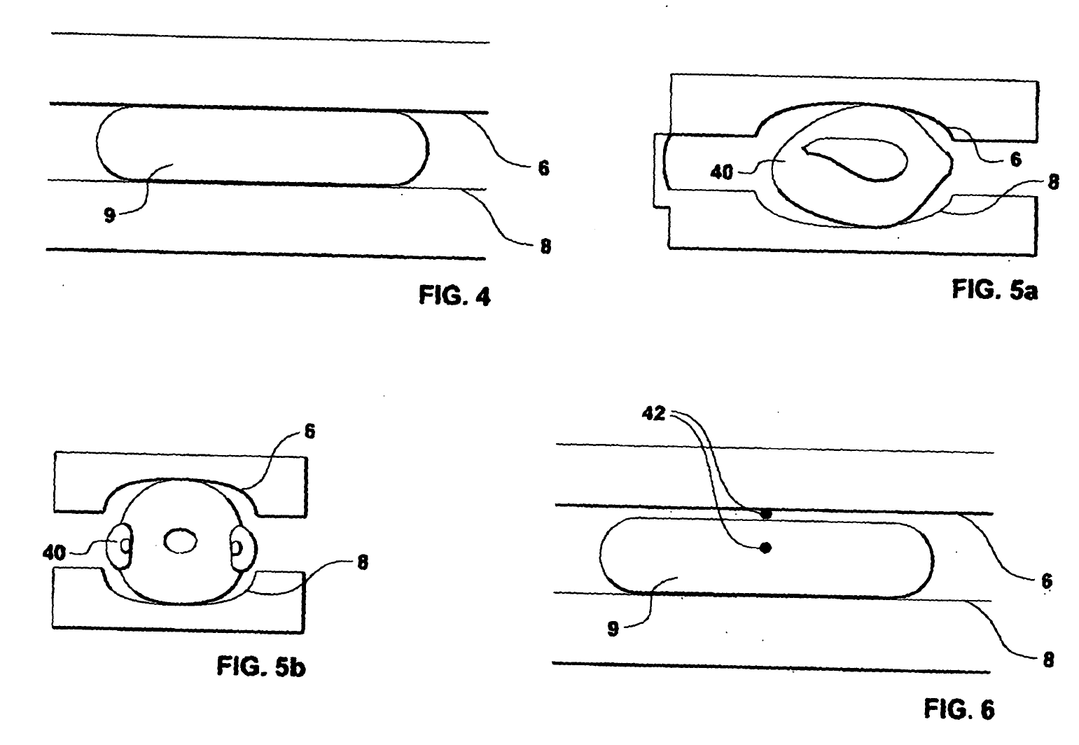

It should be envisaged that in use, the apparatus of the present invention can be used to perform ohmic heating or conventional heating independently, or to perform ohmic heating and conventional heating at the same time. Referring to FIG. 4, a cross sectional view of the 5 preferred embodiment of the present invention is shown. It can be seen that the contacting means 2 and 4 (i.e. the electrodes) include respectively substantially planar spices 6 and 8 which make contact with the entire top and bottom surfaces of the foodstuffs (which may be patties 9 or any other solid foodstuffs). The contacting surfaces 6 and 8 however can be formed into other contours, shapes or configurations so as to maximise the contacting area between the contacting surfaces 6 and 8, and the food (other than patties) to be heated, which may have an irregular shape or non-planar surface. Illustrated in FIGS. 5a and b are cross sectional views of another embodiment of the present invention with a chicken 40 therein. It can be contemplated that the efficacy and efficiency of the present invention may be substantially lower in this situation where there is imperfect or non-thorough contact between the contacting surfaces 6 and 8 and the food (chicken 40 in this case) disposed therein.

It is also envisaged that sausages can be heated or cooked by another embodiment of the present invention which consists of corrugated contacting surfaces that are tailor made to fit the contour of sausages so as to maximise the efficacy and efficiency of the present invention.

Quality of Patties Cooked by Combined Cooking

Many factors, such as cooking time, temperature, and physical properties of hamburger meat influence the heat transfer in hamburger patties during cooking. The heat transferred into hamburger patties also substantially influences the destruction of micro-organisms. It has been determined and acknowledged that in relation to conventional (i.e. double-sided contact) heating, grill heating temperature, heat transfer coefficient, and patty thickness appear to be the major factors in influencing patties centre temperature profiles. The cooking procedures of initially-frozen hamburger patty involve different phase changes, such as evaporation of water, and melting of ice and fat. For this reason, the heat transfer is believed to be non-linear and thus the melting or solidification takes place over an extended range of temperature.

It should be noted that one of the most important parameters that needs to be examined is the texture of the patties cooked by the present invention. This can be achieved by measuring the mechanical properties of the patties. Additionally, oil and water contents in the cooked patties are also very important due to their direct effect on the taste of the patties.

### EXAMPLE 3

For the purposes of testing, a further embodiment of the present invention has been devised wherein the upper and lower contacting means are modified to function as electrodes, providing both ohmic and contact heating. The following has been performed to investigate the patties' texture cooked by combined heating in comparison to that cooked by conventional contact heating: 1) extraction and measurement of the oil content; 2) extraction and measurement of the water content; and 3) measurement of the mechanical properties of the patties. An optimum heating time for both cooking methods has been determined for preparing reproducible cooked patties samples. It is generally recognised that the cooking time should not be less than fifteen seconds after the centre of the hamburger reaches 70° C. The set up for measuring the temperature of the patties is shown in FIG. 6. Thermocouples 42 have been provided and inserted into the core of the patties to monitor the changes in temperature. The standard diameter and thickness of a patty sample should be taken as 90 mm and 6 mm respectively.

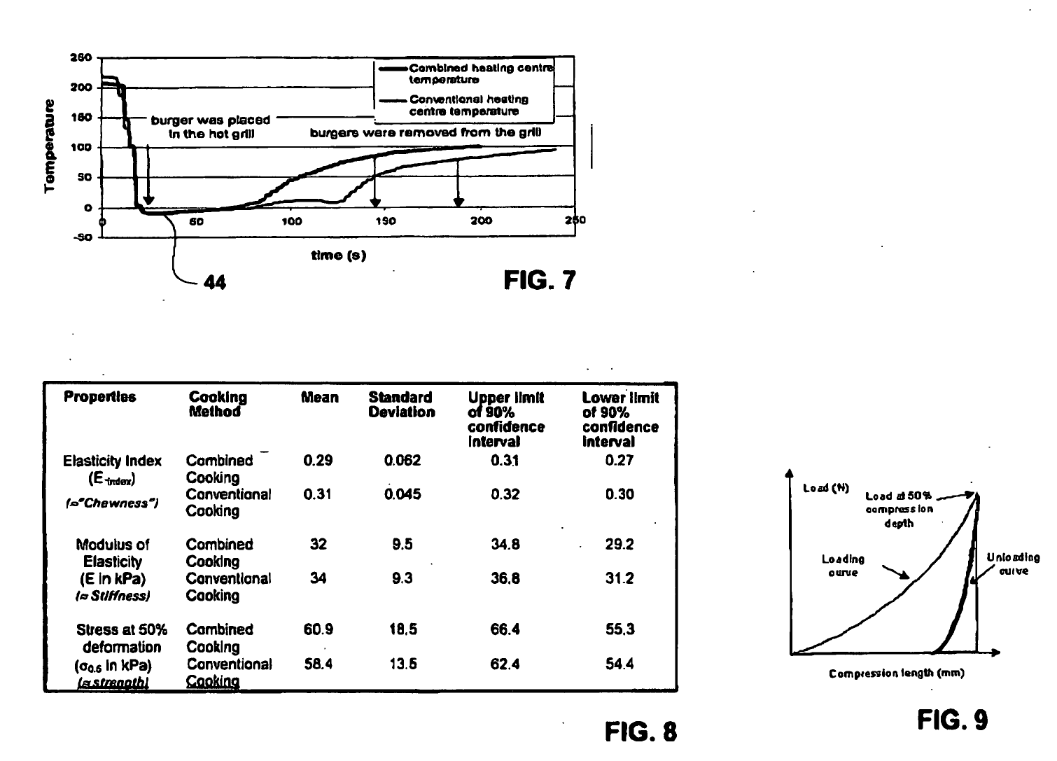

Referring now to FIG. 7, the temperature profiles of a patty cooked by conventional heating and combined heating (the applied voltage being 50V) respectively are shown. As discussed above, there is a prolonged period of time before the temperature at the core of the patty starts climbing due to the high resistivity of the patty when frozen (at approximately −20° C.). It can be clearly observed that the temperature of the core of the patty heated by combined heating starts climbing significantly earlier than that of the patty heated by conventional heating. This results in a total cooking duration of 140 seconds for combined heating, while conventional cooing takes 190 seconds. Further reductions in cooking time can be achieved by applying higher voltages (refer back to FIGS. 2 and 3).

Compression tests have been carried out to characterise the mechanical properties, including hardness, elastic modulus and elasticity index, of the patties.

Elasticity index (E_{index}) characterises the relative contributions of elastic (i.e. recoverable) and plastic (i.e. permanent) deformations. This is a ratio of the elastic energy to the total energy. Stress at 50% deformation (ρ_{0.5}) can be used as a measure of the hardness of the patty samples. Modulus of Elasticity (E) is a measure of the stiffness of the cooked patties.

A comparison of the elasticity indices, stress at 50% deformation, and elastic modulus between the patties cooked by conventional heating and combined heating was made and is illustrated in FIG. 8. The elasticity index (E_{index}) can be related and thus is a direct indication of the chewiness of the patty samples. The E_{index} data was obtained from loading and unloading curves that are schematically shown in FIG. 9. A sample with a high elastic index means it is chewy. In order to obtain hardness data, a load was applied to the surface of the samples until the compression displacement reached 2.5 mm which is about 50% of the entire thickness (5 mm) of the samples on average. The load values at 2.5 mm compression depth were then converted into stress which are also shown in FIG. 8. Stiffness (i.e. elastic modulus) has a crucial effect on taste and mouthful experience. The stiffness data is charaeterised by the slope of the loading curve up to 5% strain.

Moisture and fat contents measurements are important because they significantly affect the taste of a patty. Dry patties are considered to be less attractive to consumers. The moisture content of patties was measured by mass losses in a drying process at 105° C. The length of the drying period was determined to be 3 hours. The oil content is commonly evaluated by Soxhlet Extraction.

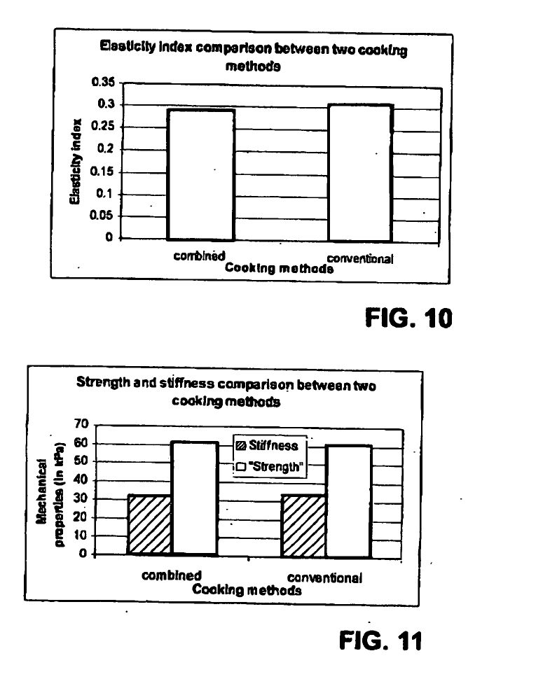

Referring now to FIGS. 10 and 11, it can be seen from the graphs that the difference in the abovementioned mechanical properties of the pares cooked by the two methods is insignificant, except that the elasticity index of the conventionally cooked or heated patties has a slightly higher value, which suggests that the patties are slightly more chewy. It can therefore be concluded that the application of ohmic heating in combination with conventional heating in patties cooking generally does not affect the taste and texture of a patty.

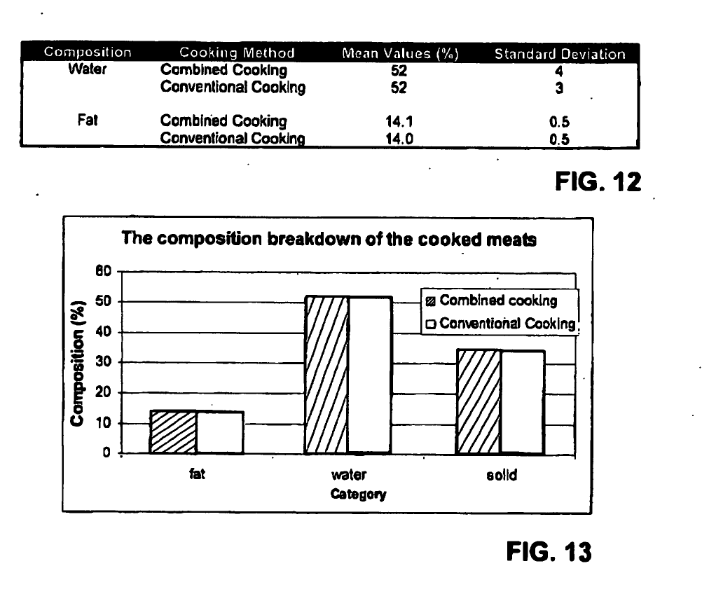

The composition of the cooked patties is defined by 3 main components, namely water, oil and others (referred to herein as solids). Oil (i.e. fat) and water measurements were obtained and are listed in FIG. 12. A breakdown of the composition of the patties 9 cooked by the two methods are represented graphically in FIG. 13. It can be observed that there is virtually no difference in the compositions of the patties cooked or heated by the two methods, which is in agreement with the taste of the patties which have been physically tasted. Also, from the insignificant variation in the water contents of patties cooked by both methods, it would be sensible to assume that moisture loss is the same in both methods.

Advantages

It can thus be seen that at least in the preferred form of the invention apparatus and a method are provided which will raise the core temperature of solid food efficiently by means of conventional heating and ohmic heating or by ohmic heating alone if desired. The present invention has been proved to be a promising method of cooking and offers at least the advantages of 1) reducing cooking time up to half the time (or even more) conventional cooking would normally take; 2) having virtually no effect, in particular detrimental effect, on the quality of the cooked food such as hamburger patties, in term of their mechanical properties, oil and moisture contents; 3) having a self terminating feature as far as the operation of ohmic heating is concerned; 4) ohmic heating and conventional heating being able to be switched on and off independently if not needed so as to save power consumption In addition, the preferred embodiment of the present invention is beneficial in that patties can be cooked in batches, but still being evenly heated (as opposed to conventional heating which may be affected by the distribution of one or more heating element(s)).

Variations:

Although the examples show the thawing and cooking of frozen hamburger patties which have a substantially uniform thickness, it is possible that this invention could be used with solid or frozen foodstuffs of non uniform dimensions and in particular non-uniform thickness. In which case multiple small contacting portions or contoured plates could be used.

It is also possible but rather less likely that this type of ohmic heating could be used in combination with other means of heating (apart from conventional contact heating) such as radiant or microwave heating.

1. A method of heating or thawing or cooking a foodstuff wherein the foodstuff is contacted by at least two surface heating means and an electric current is passed through the foodstuff to provide ohmic heating of the interior thereof.

2. A method as claimed in claim 1, wherein the current is an alternating electric current applied at between 30 and 100 Volts.

3. A method as claimed in claim 2, wherein each of the surface heating means is connected to an electrical power source, and each surface heating means has an electrically conductive surface to provide an electrical contact with the foodstuff.

4. A method as claimed in claim 3, wherein the electrical current is applied at about 70 Volts.

5. A method of cooking frozen hamburger patties which includes the steps of contacting the frozen patties with at least two surfaces heated to at least 180° C. and passing an alternating electric current of between 30 and 100 Volts through the patties to provide ohmic heating of the interior thereof.

6. A method of cooking frozen hamburger patties as claimed in claim 5, wherein the ohmic heating provides a peak power consumption of about 13 watts/cm² of surface area of each patty to be heated.

7. Apparatus suitable for heating or thawing or cooking a foodstuff which includes at least two heating means capable of supplying heat to the surface of the foodstuff, and at least two contacting means both being connectable to an electrical power source and capable of allowing an alternating current to flow through at least a portion of the foodstuff to provide ohmic heating of the interior thereof.

8. Apparatus as claimed in claim 6, wherein each of the at least two heating means also functions as one of the at least two contacting means.

9. Apparatus as claimed in claim 6, wherein means is provided to hold the heating means in electric and thermal contact with the foodstuff.

10. Apparatus as claimed in claim 6, wherein the two contacting means are provided in a clam-shell arrangement.
